(19) United States
(12) Patent Application Publication
(10) Pub. No.: US 2014/0304929 A1
(43) Pub. Date: Oct. 16, 2014

(54) ORAL UTENSIL

(71) Applicants: Heather Rechtin, St. Louis, MO (US); Christopher Hawker, Columbus, OH (US); Jessica Moreland, Columbus, OH (US); Christopher Trunek, Salt Lake City, UT (US)

(72) Inventors: Heather Rechtin, St. Louis, MO (US); Christopher Hawker, Columbus, OH (US); Jessica Moreland, Columbus, OH (US); Christopher Trunek, Salt Lake City, UT (US)

(21) Appl. No.: 14/313,998

(22) Filed: Jun. 24, 2014

Related U.S. Application Data
(63) Continuation-in-part of application No. 13/350,751, filed on Jan. 14, 2012.
(60) Provisional application No. 61/432,988, filed on Jan. 14, 2011.

(51) Int. Cl. A46B 5/00; A46B 5/02; A61C 15/04

(52) U.S. Cl. CPC A46B 5/0095; A61C 15/046; A46B 5/026; A46B 2200/1066
USPC 15/22.1; 15/145

(57) ABSTRACT

Oral utensils having at least one central protrusion are disclosed. The oral utensils are configured for modification of a gag reflex in a user of the oral utensil. The oral utensils may comprise a handle portion comprising at least one central protrusion and a first head portion comprising a dental tool, wherein the handle portion may be removably connected to the head portion.

### CROSS-REFERENCE TO RELATED APPLICATIONS

This application is a continuation-in-part of, and claims priority from, U.S. patent application Ser. No. 13/350,751, filed on Jan. 14, 2012, which claims priority to U.S. Provisional Patent Application 61/432,988, filed on Jan. 14, 2011, both of which are incorporated by reference herein in their entirety.

### BACKGROUND

Many users of oral utensils such as toothbrushes, tongue scrapers, and flossing tools suffer from gag reflexes. Often, such reflexes are initiated when oral utensils approach the rear of the mouth near the throat.

Palm pressure points identified by researchers have been demonstrated to affect physiological phenomena relevant to oral care, including for instance modification of the gag reflex. The various pressure points present in the palm of the user that have been identified to have physiological effect may be referred to collectively as the “pressure point.” The application of force onto the pressure point has been found to reduce the gag reflex that a user of an oral utensil may experience.

A device is disclosed for use as an oral utensil. The device is configured to selectively apply force upon the pressure point linked to modification of the gag reflex.

### SUMMARY

In one embodiment, an oral utensil for performing oral hygiene is provided, the oral utensil comprising: a handle portion comprising at least one central protrusion; a first head portion comprising a dental tool; wherein the handle portion is removably connected to the head portion.

In another embodiment, an oral utensil for performing oral hygiene is provided, the oral utensil comprising: a handle portion comprising at least one central protrusion; a first head portion comprising a toothbrush having bristles between about 7.0 mm and about 10.0 mm in length; wherein the handle portion is removably connected to the head portion.

In another embodiment, an oral utensil for performing oral hygiene is provided, the oral utensil comprising: a handle portion comprising at least one central protrusion; a first head portion comprising a toothbrush having bristles between about 7.0 mm and about 10.0 mm in length; wherein the handle portion is rotatably and removably connected to the head portion.

### BRIEF DESCRIPTION OF THE DRAWINGS

The accompanying figures, which are incorporated in and constitute a part of the specification, illustrate various example apparatuses, systems, and methods, and are used merely to illustrate various example embodiments.

FIG. 1 illustrates an example arrangement of an oral utensil in a first condition.

FIG. 2 illustrates an example arrangement of an oral utensil in a second condition.

FIG. 3 illustrates an example arrangement of a head portion of an oral utensil.

FIG. 4 illustrates an example arrangement of a head portion of an oral utensil.

FIG. 5 illustrates an example arrangement of a handle portion of an oral utensil.

FIG. 6 illustrates an example arrangement of a handle portion of an oral utensil.

### DETAILED DESCRIPTION

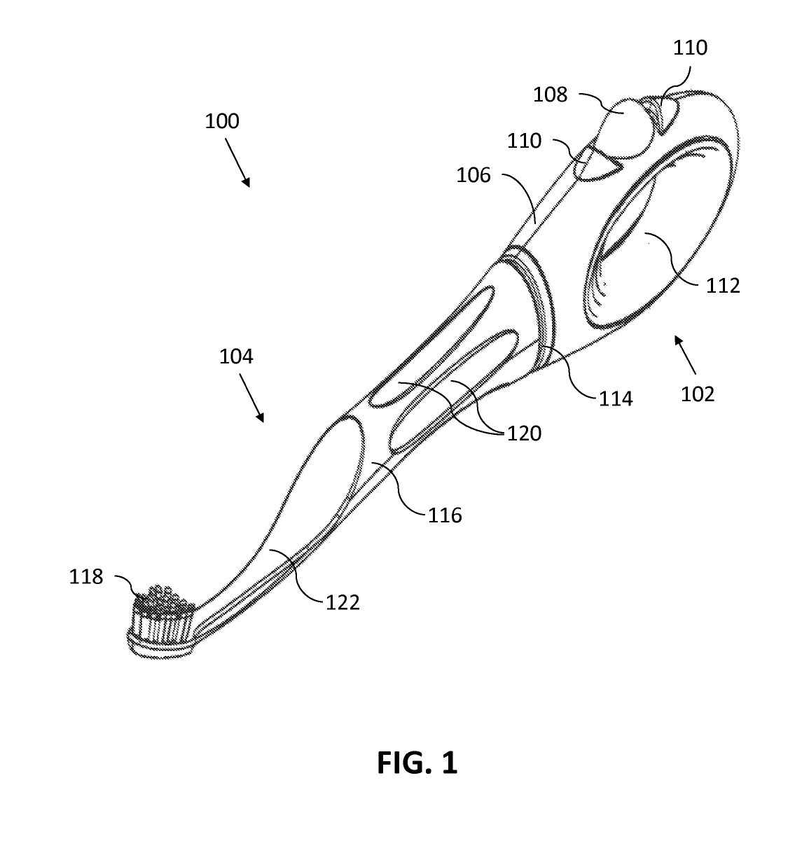

FIG. 1 illustrates an example arrangement of an oral utensil 100 in a first condition. Oral utensil 100 comprises a handle portion 102 and a head portion 104. Handle portion 102 may comprise a handle body 106, at least one central protrusion 108, at least one lateral protrusion 110. Handle portion 102 may comprise at least one aperture 112. Handle portion 102 and head portion 104 may be connected via a joint 114. Head portion 104 may comprise a head body 116, a dental tool 118, at least one gripping element 120, and a neck portion 122.

Oral utensil 100 may comprise any of a variety of materials, including one or more of a metal, an alloy, a composite, a polymer, or another organic material or biocompatible material.

Handle portion 102 may comprise an ergonomically shaped structure configured for gripping by a user's hand. In one embodiment, handle portion 102 comprises a shape configured to properly position at least one central protrusion 108 in the palm of a user such that at least one central protrusion 108 is forced into the user's pressure point.

In one embodiment, handle portion 102 comprises a grip enhancement (not shown), such as ribs, serrations, stippling, ridges, or other texturing configured to increase the coefficient of friction between a user's hand and handle portion 102. In another embodiment, at least a portion of handle portion 102 comprises a grip enhancement comprising an overmolded resilient material, such as a rubber or silicone material. In another embodiment, handle portion 102 comprises a grip enhancement that is integrally connected to handle portion 102. In another embodiment, handle portion 102 comprises a grip enhancement that is removably connected to handle portion 102.

Handle body 106 may comprise a substantially rounded body ergonomically configured for gripping in a user's hand. Handle body 106 may be configured to be cleaned or sterilized without suffering damage.

At least one central protrusion 108 may comprise a substantially semispherical element raised from handle body 106. In another embodiment, at least one central protrusion 108 comprises a substantially semi-ellipsoidal element raised from handle body 106. At least one central protrusion 108 may comprise a density selected to apply a specific range of force to a user's pressure point while a user is holding handle portion 102. At least one central protrusion 108 may comprise a substantially rigid material. In one embodiment, handle portion 102 comprises at least two central protrusions 108. In another embodiment, handle portion 102 comprises a plurality of central protrusions 108 oriented to provide pressure to one or more pressure points in a user's hand.

In one embodiment, at least one central protrusion comprises a radius between about 7.0 mm and about 50.0 mm. In another embodiment, at least one central protrusion comprises a radius between about 12.0 mm and about 40.0 mm. In another embodiment, at least one central protrusion comprises a radius between about 15.0 mm and about 25.0 mm.

In one embodiment, oral utensil 100 is an electric toothbrush, electric tongue scraper, or electric flossing apparatus. Oral utensil 100 may comprise an electric motor operably and/or electrically connected to a switch. In one embodiment, oral utensil 100 comprises an electric power source, such as a battery, an electric plug, or a generator. The battery may be either of a rechargeable battery or a disposable battery. The switch may be operatively connected to at least one central protrusion 108 such that depressing at least one central protrusion 108 activates the electric motor. In one embodiment, the switch comprises a biasing member configured to bias the switch and/or at least one central protrusion 108 to a deactivated upward position, wherein a user must overcome the biasing member to activate the switch. In this embodiment, a user must apply at least a minimum pressure to at least one central protrusion 108 to activate the switch and electric motor. The pressure required to overcome the biasing member may be specifically selected to ensure that a user applies a desired amount of pressure to the user's pressure point.

In one embodiment, at least one lateral protrusion 110 is oriented adjacent to at least one central protrusion 108. In another embodiment, handle portion 102 comprises two lateral protrusions 110 oriented on either side of and adjacent to at least one central protrusion 108. In one embodiment, at least one lateral protrusion 110 comprises a tapered shape having a greater thickness adjacent to at least one central protrusion 108 and a lesser thickness away from central protrusion 108, such that at least one lateral protrusion 110 fades into handle body 106.

In one embodiment, handle portion 102 comprises at least one aperture 112. At least one aperture 112 may be at least one of a substantially circular or oval aperture. At least one aperture 112 may be configured to allow a user to extend the user's fingers therethrough. In one embodiment, at least one aperture 112 may be configured to reduce the weight of, or material necessary for, handle portion 102. In another embodiment, at least one aperture 112 is configured to allow a user to hang oral utensil 100 for storage or drying, while keeping dental tool 118 from touching potentially contaminating surfaces.

In one embodiment, handle portion 102 comprises a thickness and weight configured such that when handle portion 102 is laid upon a substantially flat surface, dental tool 118 does not contact the flat surface.

Oral utensil 100 may comprise a joint 114. In one embodiment, joint 114 is configured to allow selective rotation between handle portion 102 and head portion 104, such that a user may selectively orient head portion 104 relative to handle portion 102 in order to suit a user's desired implementation of oral utensil 100. In another embodiment, joint 114 is configured to allow handle portion 102 and head portion 104 to move relative to one another in any of a variety of mechanisms, including extension, refraction, translation, and bending. In another embodiment, joint 114 is configured to allow handle portion 102 and head portion 104 to selectively separate, and may include any of a variety of attachment mechanisms, including a friction fitting, threads, a bayonet fitting, a snap, and a hook.

In one embodiment, joint 114 is configured to allow rotation between handle portion 102 and head portion 104, wherein joint 114 is configured such that causing the rotation requires a specified range of torque. In one embodiment, joint 114 is configured such that a user may rotate head portion 104 relative to handle portion 102 with a single hand.

Head portion 104 may comprise a head body 116. In one embodiment, head body 116 comprises a substantially rigid material. In another embodiment, head body 116 comprises a substantially resilient material.

Head portion 104 comprises a dental tool 118. Dental tool 118 may comprise any of a toothbrush, a tongue scraper, and a flossing tool. In another embodiment, dental tool 118 may comprise a pick, scraper, or other dental tool.

Dental tool 118 may comprise a toothbrush comprising bristles. In one embodiment, the bristles comprise a profile that is substantially concave in appearance, such that bristles on the edges of dental tool 118 are longer than bristles in the center of dental tool 118. In one embodiment, bristles comprise a length between about 4.0 mm and about 14.0 mm. In another embodiment, bristles comprise a length between about 6.0 mm and about 12.0 mm. In another embodiment, bristles comprise a length between about 7.0 mm and about 10.0 mm. In one embodiment, the centrally located bristles are about 7.0 mm in length while the bristles about the edges of dental tool 118 are about 10.0 mm in length.

In one embodiment, handle portion 102 and head portion 104 are configured to selectively separate. In one embodiment, handle portion 102 and head portion 104 separate for travel purposes, replacement of head portion 104, or interchanging of a first head portion 104 having a first dental tool 118 for a second head portion 104 having a second dental tool 118.

Head body 116 may comprise at least one gripping element 120. At least one gripping element 120 may comprise any of a groove, rib, ridge, serration, dimples, or other textured surface capable of creating an increased coefficient of friction about head body 116. Gripping element 120 may be configured to allow a user to at least one of stabilize, manipulate, and rotate head portion 104.

Head portion 104 may comprise a neck portion 122. Neck portion 122 may comprise a thinner profile for less obtrusive insertion of dental tool 118 into a user's mouth. In one embodiment, neck portion 122 is substantially rigid. In another embodiment, neck portion 122 is substantially resilient. In another embodiment, neck portion 122 is substantially flexible. In one embodiment, neck portion 122 is substantially arcuate in profile. In another embodiment, neck portion 122 is substantially straight in profile.

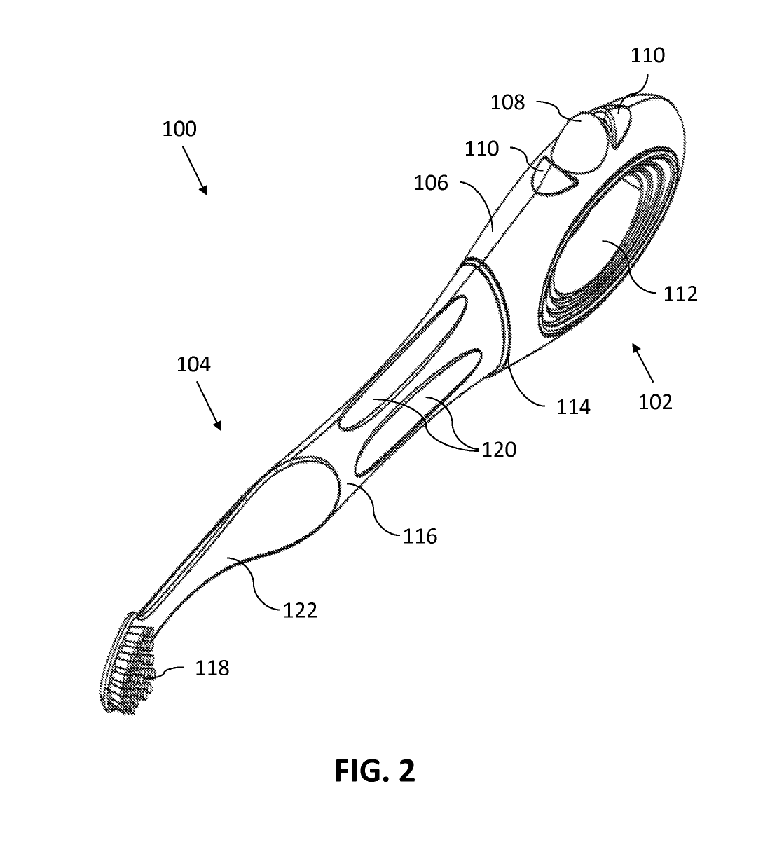

FIG. 2 illustrates an example arrangement of oral utensil 100 in a second condition wherein head portion 104 is rotated relative to handle portion 102.

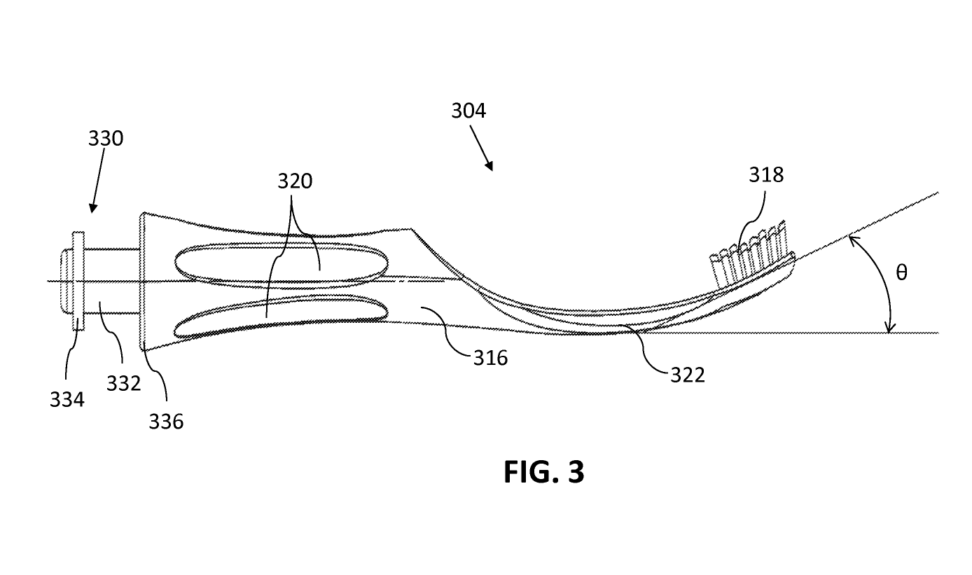

FIG. 3 illustrates an example arrangement of a head portion 304 of an oral utensil. Head portion 304 may comprise a head body 316, a dental tool 318, at least one gripping element 320, and a neck portion 322.

In one embodiment, head portion 304 comprises a head coupling mechanism 330. In one embodiment, head coupling mechanism 330 comprises an elongated member 332, a rib 334, and a shoulder 336. Rib 334 may extend out of and be integrated with elongated member 332. In another embodiment, rib 334 comprises a separable member removably attached to elongated member 332. In one embodiment, rib 334 is configured to create a friction fit with a corresponding handle coupling mechanism (not shown).

In one embodiment, elongated member 332 is substantially cylindrical. In another embodiment, elongated member 332 is substantially conical. In another embodiment, elongated member 332 tapers with a greater diameter near its proximal end and a smaller diameter near its distal end.

In one embodiment, rib 334 comprises a solid continuous circumferential rib. In another embodiment, rib 334 comprises a series of interruptions. In another embodiment, rib 334 comprises a series of raised knobs oriented substantially circumferentially about elongated member 332.

In one embodiment, head coupling mechanism 330 is a substantially male fitting. In one embodiment, handle portion (not shown) comprises a substantially female handle coupling mechanism, configured to correspond to and engage with head coupling mechanism 330. In another embodiment, head coupling mechanism 330 and a handle coupling mechanism (not shown) are configured to removably connected to one another.

In one embodiment, neck portion 322 comprises a substantially arcuate profile. In one embodiment, dental tool 318 is oriented at θ degrees relative to the longitudinal axis of head portion 304. In one embodiment, θ is between about −45 degrees and about 90 degrees. In another embodiment, θ is between about 0 degrees and about 45 degrees. In another embodiment, θ is between about 15 degrees and about 35 degrees.

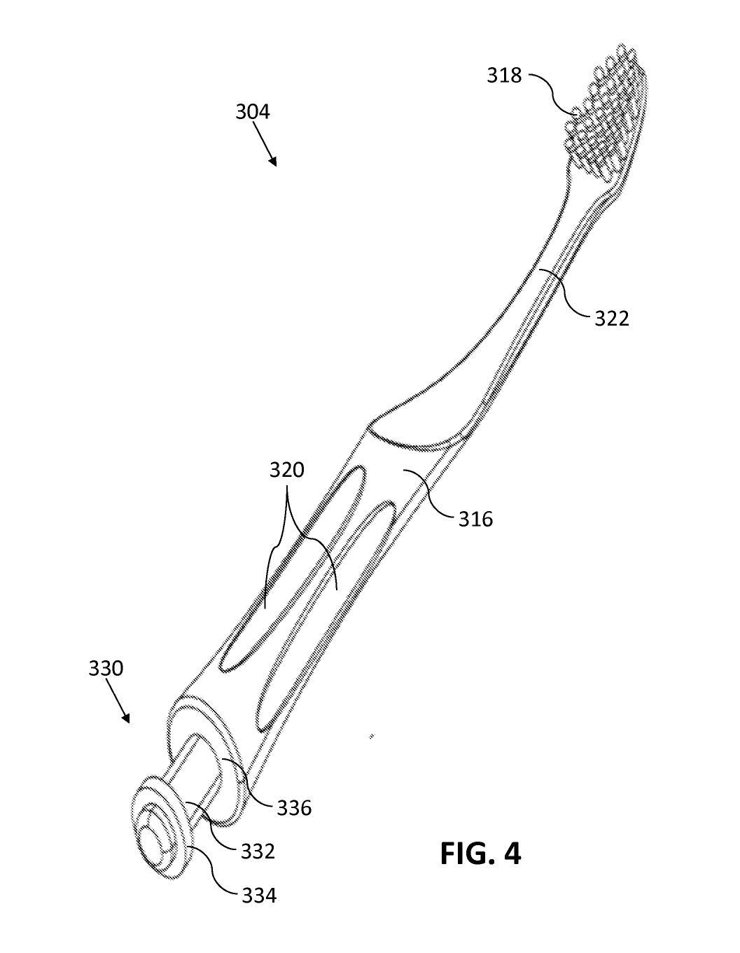

FIG. 4 illustrates an example arrangement of head portion 304 of an oral utensil. Shoulder 336 may be a substantially planar surface extending substantially orthogonally to the longitudinal axis of head portion 304. Shoulder 336 may at least partially engage a corresponding element in the handle portion (not shown).

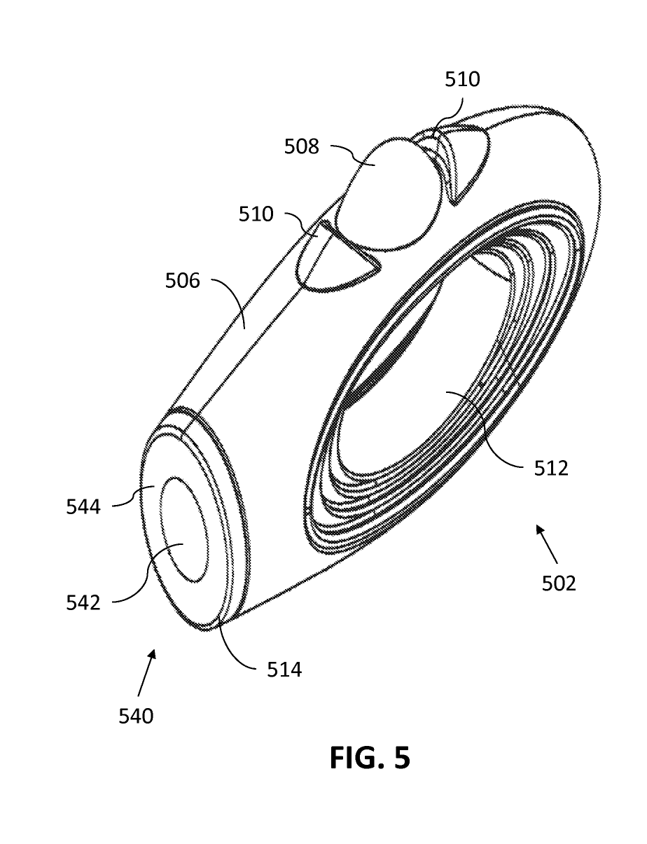

FIG. 5 illustrates an example arrangement of a handle portion 502 of an oral utensil. Handle portion 502 may comprise a handle body 506, at least one central protrusion 508, at least one lateral protrusion 510. Handle portion 502 may comprise at least one aperture 512. Handle portion 502 and a head portion (not shown) may be connected via a joint 514.

In one embodiment, at least one aperture 512 comprises a series of concentric ridges in a step pattern.

Handle portion 502 may comprise a handle coupling mechanism 540 comprising a central void 542 extending at least partially into handle body 506. Handle coupling mechanism 540 may comprise a face portion 544.

Central void 542 may comprise at least one of a substantially cylindrical void and a substantially conical void. Face portion 544 may comprise a substantially planar surface extending substantially orthogonally to the longitudinal axis of handle portion 502.

In one embodiment, central void 542 is configured to engage an elongated member of a head portion (not shown), such as elongated member 332 illustrated in FIGS. 3 and 4. In another embodiment, face portion 544 is configured to at least partially abut or engage a shoulder of a head portion (not shown), such as shoulder 336 illustrated in FIGS. 3 and 4. In one embodiment, handle coupling mechanism 540 is configured to rotatably connect to a head coupling mechanism (not shown).

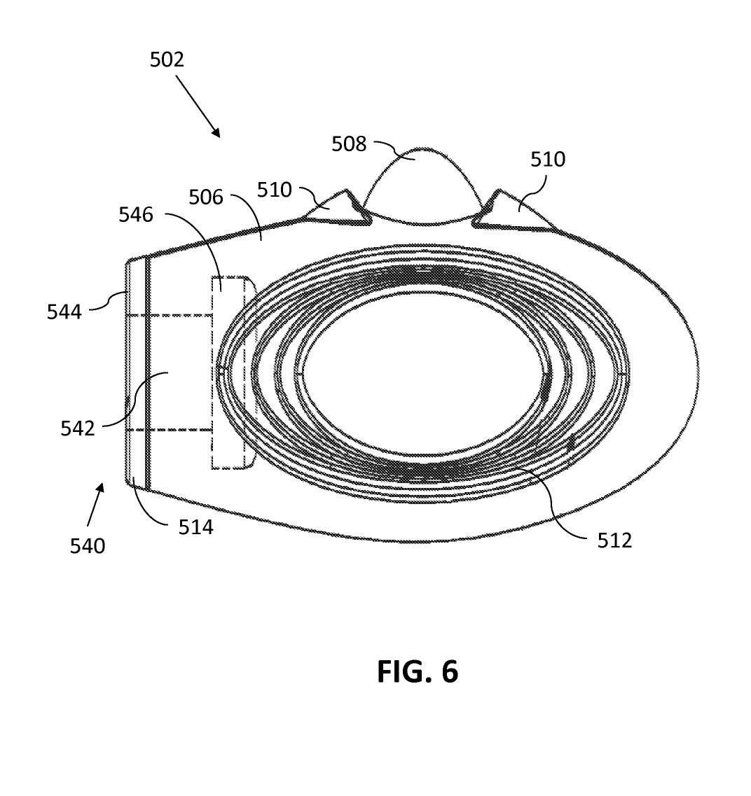

FIG. 6 illustrates an example arrangement of handle portion 502. As illustrated by phantom lines, central void 542 extends at least partially into handle body 506. In one embodiment, an interior channel 546 is in communication with central void 542, which interior channel 546 is configured to engage a rib of a handle portion (not shown), such as rib 334 illustrated in FIGS. 3 and 4. In another embodiment, interior channel 546 is configured to at least partially engage a substantially circumferential line of knobs oriented on an elongated member of a handle portion (not shown), such as elongated member 332 illustrated in FIGS. 3 and 4.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. To the extent that the term “substantially” is used in the specification or the claims, it is intended to mean that the identified components have the relation or qualities indicated with degree of error as would be acceptable in the subject industry. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

What is claimed is:

1. An oral utensil for performing oral hygiene, the oral utensil comprising:
a handle portion comprising at least one central protrusion;
a first head portion comprising a dental tool;
wherein the handle portion is removably connected to the head portion.

2. The oral utensil of claim 1:
wherein the handle portion comprises a handle coupling mechanism;
wherein the first head portion comprises a head coupling mechanism; and
wherein the handle portion and the head portion are removably connected through the handle coupling mechanism and the head coupling mechanism.

3. The oral utensil of claim 1, wherein the dental tool comprises at least one of a toothbrush, tongue scraper, and a flossing tool.

4. The oral utensil of claim 1, further comprising a second head portion, wherein the first head portion is removable from the handle portion, and wherein the second head portion is attachable to the handle portion.

5. The oral utensil of claim 1, wherein the head portion is rotatably connected to the handle portion.

6. The oral utensil of claim 1, wherein the dental tool is a toothbrush having bristles between about 7.0 mm and about 10.0 mm in length.

7. The oral utensil of claim 1, wherein the handle portion comprises a grip enhancement comprising a rubber material.

8. The oral utensil of claim 1, wherein the at least one central protrusion is configured to contact a user's palm when a user is gripping the oral utensil.

9. The oral utensil of claim 1, further comprising an electric motor.

10. The oral utensil of claim 1:
wherein the handle portion comprises a central void;
wherein the head portion comprises an elongated member; and
wherein the central void is configured to engage the elongated member.

11. An oral utensil for performing oral hygiene, the oral utensil comprising:
a handle portion comprising at least one central protrusion;
a first head portion comprising a toothbrush having bristles between about 7.0 mm and about 10.0 mm in length;
wherein the handle portion is removably connected to the head portion.

12. The oral utensil of claim 11:
wherein the handle portion comprises a handle coupling mechanism;
wherein the first head portion comprises a head coupling mechanism; and
wherein the handle portion and the head portion are removably connected through the handle coupling mechanism and the head coupling mechanism.

13. The oral utensil of claim 11, further comprising a second head portion, wherein the first head portion is removable from the handle portion, and wherein the second head portion is attachable to the handle portion.

14. The oral utensil of claim 11, wherein the head portion is rotatably connected to the handle portion.

15. The oral utensil of claim 11, wherein the handle portion comprises a grip enhancement comprising a rubber material.

16. The oral utensil of claim 11, wherein the at least one central protrusion is configured to contact a user's palm when a user is gripping the oral utensil.

17. The oral utensil of claim 11, further comprising an electric motor.

18. An oral utensil for performing oral hygiene, the oral utensil comprising:
a handle portion comprising at least one central protrusion;
a first head portion comprising a toothbrush having bristles between about 7.0 mm and about 10.0 mm in length;
wherein the handle portion is rotatably and removably connected to the head portion.

19. The oral utensil of claim 18:
wherein the handle portion comprises a handle coupling mechanism;
wherein the first head portion comprises a head coupling mechanism; and
wherein the handle portion and the head portion are removably connected through the handle coupling mechanism and the head coupling mechanism.

20. The oral utensil of claim 18, further comprising a second head portion, wherein the first head portion is removable from the handle portion, and wherein the second head portion is attachable to the handle portion.
